(19) United States
(12) Patent Application Publication
(10) Pub. No.: US 2006/0276197 A1
(43) Pub. Date: Dec. 7, 2006

(54) Method for allocating multi access channels at the time of call setup in a mobile communication system

(75) Inventor: Hyun Gu Heo, Gyeonggi-do (KR)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UTStarcom Korea Limited

(21) Appl. No.: 10/560,696

(22) PCT Filed: Jul. 26, 2004
(86) PCT No.: PCT/KR04/01883

§ 371 Date: Jun. 26, 2006

(30) Foreign Application Priority Data
Jul. 25, 2003 (KR) 10-2003-0051470

(51) Int. Cl. H04Q 7/20

(52) U.S. Cl. 455/450

(57) ABSTRACT

There is provided a method for allocating multiple access channels at the time of call setup in a mobile communication system, wherein the method comprises the steps of: informing a mobile station that a modem of a base station is using one access channel; dividing a coverage area of the base station into a number of sub-areas; allocating a number of access channels such that each of the access channels covers its corresponding sub-area; monitoring the access channels to determine whether an access probe transmitted from the mobile station has been acquired; and if the access probe has been acquired, outputting the acquired access probe to the channel card and releasing the remaining access channels. The method reduces a call setup time and improves the call setup services by dividing a coverage area of a base station into several sub-areas according to a distance from the base station and allocating each of the access channels to the corresponding sub-area so that the search window size of each access channel diminishes.

### TECHNICAL FIELD

The present invention generally relates to a method of allocating an access channel at the time of call setup in a mobile communication system, and more particularly to a method of allocating multi access channels to reduce a call setup time and improve call setup services by dividing a coverage area of a base station into several sub-areas according to a distance from the base station and allocating each of the access channels to the corresponding sub-area so that the search window size of each access channel diminishes.

### BACKGROUND ART

A conventional method for allocating an access channel at a call setup in a mobile communication system allocates only one access channel regardless of the coverage size of the base station. It is possible, of course, that the conventional method increases the number of access channels per paging channel. However, it allocates the increased access channels to search the whole coverage area, not each of the sub-areas that result from dividing the coverage area of a base station. Thus, the multi access channels search only the access probes that are transmitted at the same time from a mobile station. As such, the probability for access probe acquisition decreases when the coverage area of a base station is large. It increases a call setup time and prevents a call setup service of good quality from being provided.

Also, if an access probe transmitted from a mobile station has not been acquired by a base station, then the mobile station keeps transmitting the access probe continuously to thereby raise the power by P1 until its access probe is acquired by the base station. The power-raising relation of the access probe of the mobile station is illustrated in FIG. 1. Therefore, if a base station fails to acquire the access probe of a mobile station in a short amount of time, then the access probe power of the mobile station rises. This worsens the wireless environment of a reverse link.

### DISCLOSURE OF INVENTION

### Technical Problem

It is, therefore, an object of the present invention to address the foregoing deficiency through a method of allocating multiple access channels at the time of call setup in a mobile communication system to reduce a call setup time and stabilize a reverse-link wireless environment.

### Technical Solution

In accordance with the present invention, there is provided a method of allocating multiple access channels at the time of call setup in a mobile communication system comprising a number of mobile stations and a base station having a modem and a channel card. The method comprises the steps of:

informing a mobile station that the modem of the base station is using one access channel by an access parameter message, which is a paging channel message;

dividing a coverage area of the base station into a number of sub-areas;

allocating a number of access channels such that each of the access channels covers its corresponding sub-area;

monitoring the access channels to determine whether an access probe transmitted from the mobile station has been acquired; and

if the access probe has been acquired, outputting the acquired access probe to the channel card and releasing the remaining access channels.

The foregoing and other objects and features of the present invention will become more fury apparent from the following description, appended claims and their accompanying drawings.

### BRIEF DESCRIPTION OF THE DRAWINGS

These drawings depict only the preferred embodiments of the present invention and should not be considered as limitations of its scope. These as well as other features of the present invention will become more apparent upon reference to the drawings in which:

FIG. 1 is a graph for showing an access probe sequence transmitted from a mobile station at the time of call setup in a typical mobile communication system.

FIG. 2 is a view for showing a conventional method for allocating an access channel at the time of call setup in a mobile communication system.

FIG. 3 is a block diagram of an apparatus for allocating multiple access channels at the time of call setup in a mobile communication system in accordance with an embodiment of the present invention.

FIG. 4 is a flow chart illustrating a method for allocating multiple access channels at the time of call setup in a mobile communication system in accordance with an embodiment of the present invention.

FIG. 5 is a view for explaining the method for allocating multiple access channels at the time of call setup in a mobile communication system shown in FIG. 4.

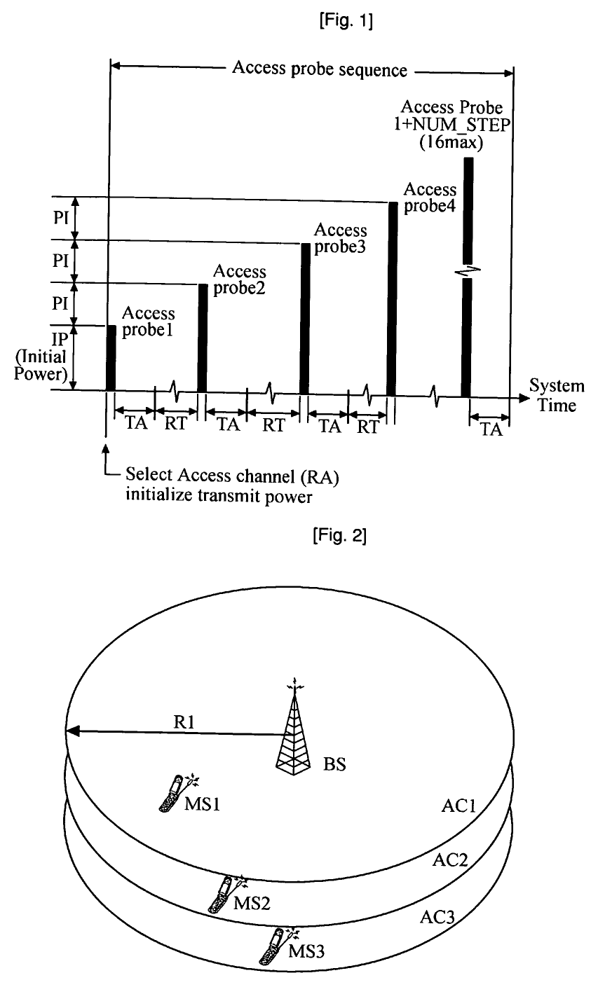

### BEST MODE FOR CARRYING OUT THE INVENTION

A preferred embodiment of the present invention will now be described in detail in accordance with the accompanying drawings.

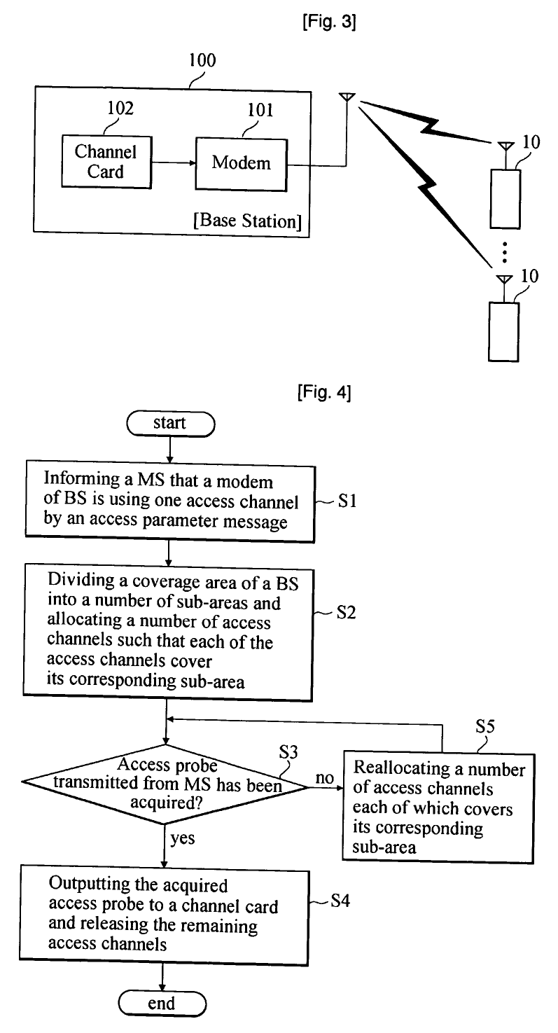

FIG. 3 is a block diagram of an apparatus for allocating multiple access channels at the time of call setup in a mobile communication system in accordance with an embodiment of the present invention. As shown in FIG. 3, the apparatus includes a base station 100 having a modem 101 and a channel card 102. The modem 101 of the base station 100 informs a mobile station 10 that it is using one access channel by an access parameter message, which is a paging channel message. The modem 101 thereafter divides its coverage area into a number of sub-areas and allocates a number of access channels such that each of the access channels covers its corresponding sub-area. The modem 101 determines whether an access probe transmitted from the mobile station 10 has been acquired by monitoring the multi access channels, each of which covers its corresponding sub-area. If the access probe has been acquired, then the modem 10 outputs the acquired access probe to the channel card and releases the remaining access channels.

A function of the channel card 102 in the base station 100 is well known in the field of mobile communication systems and thus will not be explained herein.

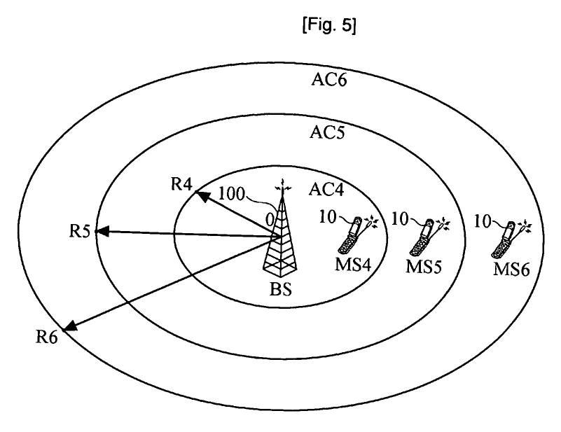

Referring now to FIGS. 4 and 5, there is provided a method for allocating multiple access channels at the time of call setup in a mobile communication system in accordance with an embodiment of the present invention and using the above-mentioned apparatus.

In step S1, the modem 101 of the base station 100 informs a mobile station 10 that it is using one access channel by an access parameter message, which is a paging channel message.

Then, in step S2, the modem 101 divides its coverage area into a number of sub-areas (illustrated in FIG. 5) and allocates a number of access channels such that each of the access channels covers its corresponding sub-area.

More specifically, the modem 101 sets each of the access channels to have a long code mask by using the same paging channel ID and the same access channel ID. Also, the modem 101 sets Search Start Offset parameter and Search Window Size parameter to each of the sub-areas so that each access channel searches a different sub-area.

Provided below is a more detailed explanation of the allocating method for multi access channels under the assumption that the modem 101 opens three access channels (shown in FIG. 5).

First, the modem 101 sets Access Channel 4 (AC4) to search within the radius of R4 from the base station 100. To accomplish this, the modem 101 sets “Search Start Offset=0 (unit: ⅛ pn_chips)” and “Search Window Size=S4 (unit: 64 pnchips)” for the parameters of AC4 (shown in FIG. 5). The S4 is a size of the search window searching the radius R4. If “S4=2,” since there is 244M propagation delay per 1 pn_chip, R4 is approximately 31 km (see Eq. 1) and AC4 searches the access probe within the radius of 31 km.
R4=2×64(pn_chips)×244(M/pn_chip)=31232M <Eq. 1>

Second, the modem 101 sets Access Channel 5 (AC5) to search the radius from R4 to R5. To accomplish this, the modem 101 sets “Search Start Offset=2×64(pn_chips)×8(⅛ pn_chips)=1024(⅛ pn_chips)” and “Search Window Size=S5(64 pn_chips)” for the parameters of AC5 (shown in FIG. 5). The S5 is a size of the search window searching within the radii R4 and R5. If “S5=2,” since the searching area would be within 31 km and 62 km from the base station 100, R5 is approximately 31 km (see Eq. 2) and AC5 searches the access probe within the radius of 31 km.
R5=2×64(pn_chips)×244(M/pn_chip)=31232M <Eq. 2>

Third, the modem 101 sets Access Channel 6 (AC6) to search the radius from R5 to R6. To accomplish this, the modem 101 sets “Search Start Offset=(2+2)×64(pn_chips)×8(⅛ pn_chips)=2048(⅛ pn-chips)” and “Search Window Size=S6(64 pn_chips)” for the parameters of AC6 (shown in FIG. 5). The S6 is a size of the search window searching within the radii R5 and R6. If “S6=2,” since the searching area would be within 62 km and 93 km from the base station 100, R6 is approximately 31 km (see Eq. 3) and AC6 searches the access probe within the radius of 31 km.
R6=2×64(pn_chips)×244(M/pn_chip)=31232M <Eq. 3>

In step S3, the modem 101 determines whether an access probe transmitted from the mobile station 10 has been acquired by monitoring the multi access channels, each of which covers its corresponding sub-area.

In step S4, if the access probe transmitted by the mobile station 10 has been acquired by one of the multi access channels (YES) in step S3, then the modem 101 outputs the acquired access probe to the channel card 102 and releases the remaining access channels.

In step S5, on the other hand, if the access probe has not been acquired by one of the multi access channels (No) in step S3, then the modem 101 reallocates the multi access channels, each of which covers the corresponding sub-area and undergoes step S3 again.

### INDUSTRIAL APPLICABILITY

The present invention is directed to a method of allocating multi access channels to reduce a call setup time, thereby improving the call setup services by dividing a coverage area of the base station into several sub-areas. It further allocates each of the access channels to the corresponding areas so that the search window size of each access channel diminishes.

Also, the reduced call setup time by the present invention allows a mobile station to attempt an access probe at a lower power. Further, it stabilizes a reverse-link wireless environment by preventing the access noise of the mobile station.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the scope of the invention.

1. A method for allocating multiple access channels at a time of call setup in a mobile communication system including a number of mobile stations and a base station having a modem and a channel card, said method comprising the steps of:
informing a mobile station that the modem of the base station is using one access channel by an access parameter message, which is a paging channel message;
dividing a coverage area of the base station into a number of sub-areas;
allocating a number of access channels such that each of the access channels covers its corresponding sub-area;
monitoring the access channels to determine whether an access probe transmitted from the mobile station has been acquired; and
if the access probe has been acquired, outputting the acquired access probe to the channel card and releasing the remaining access channels.

2. The method in accordance with claim 1, wherein if an access probe transmitted from the mobile station has not been acquired in said determining step, the method further comprises the step of reallocating a number of access channels, each of which covers its corresponding sub-area and undergoes said determining step again.

3. The method in accordance with claim 1, wherein said allocating step sets each of the access channels to have a long code mask by using the same paging channel ID and the same access channel ID, and sets Search Start Offset parameter and Search Window Size parameter to each of the sub-areas so that each access channel searches a different sub-area.
